(19) United States
(12) Patent Application Publication
(10) Pub. No.: US 2025/0118130 A1
(43) Pub. Date: Apr. 10, 2025

(54) GAMING MACHINE AND METHOD WITH TRANSMISSIVE DISPLAY AREA AND CAMERA

(71) Applicant: Everi Games Inc., Austin, TX (US)

(72) Inventors: Daniel Gibson, Austin, TX (US); Keith Riggs, Austin, TX (US)

(73) Assignee: Everi Games Inc., Austin, TX (US)

(21) Appl. No.: 18/399,371

(22) Filed: Dec. 28, 2023

Related U.S. Application Data
(60) Provisional application No. 63/543,056, filed on Oct. 7, 2023.

(51) Int. Cl. G07F 17/32

(52) U.S. Cl. CPC G07F 17/3206; G07F 17/3211; G07F 17/3216

(57) ABSTRACT

A gaming machine using a camera, and method, and program product for controlling such are provided. A gaming machine includes a cabinet having a front side and at least one player input device, and a video display system mounted in the cabinet and comprising a video display device with a transmissive display area. At least one electronic controller is connected to the player input device and the video display system and programmed for presenting a gaming result responsive to a player input. An electronic camera mounted in the cabinet behind the transmissive display area includes a lens positioned for imaging through the transmissive display area.

### TECHNICAL FIELD OF THE INVENTION

The invention relates to gaming machines including a transmissive display area that can display graphics and also become transparent.

### BACKGROUND OF THE INVENTION

Gaming machines, commonly referred to as “slot machines,” sometimes use cameras for player tracking, casino security, and using player images in gaming related graphics. Electronic cameras for this purpose are sometimes mounted along the top of a gaming machine cabinet, or along the front face of the gaming machine.

Gaming may include one or more mechanical rotating elements such as physical reels used to form a matrix of symbol locations. The reels may also be simulated. The reels carry game symbols on their periphery and the rotational position of the reels determine the game symbols that line up along one or more paylines defined across the matrix of symbol locations for a given play in the game to indicate the result of the play, some prize or a loss.

### SUMMARY OF THE INVENTION

A gaming machine using a camera, and method, and program product for controlling such are provided. A gaming machine includes a cabinet having a front side and at least one player input device, and a video display system mounted in the cabinet and comprising a video display device with a transmissive display area. At least one electronic controller is connected to the player input device and the video display system and programmed for presenting a gaming result responsive to a player input. An electronic camera may be mounted in the cabinet behind the transmissive display area and includes a lens positioned for imaging through the transmissive display area.

An object of the present invention is to provide an improved way to acquire images or video of a player at a gaming machine. Other objects of the invention include providing control techniques for controlling transmissive displays to allow use with cameras and a variety of mechanical reel arrangements and simulated reel arrangements. Another object of the invention is to allow placement of cameras within gaming cabinets in an unobtrusive manner, and to simplify the construction of gaming cabinets or their displays for applications with which a camera is required.

A gaming machine according to a first aspect of the present invention includes a cabinet with a front side and at least one player input device. A video display system is mounted in the cabinet and comprising a video display device with a transmissive display area. At least one electronic controller is electrically connected to the at least one player input device and the video display system and programmed for presenting a gaming result responsive to an input from the player input device. An electronic camera is mounted in the cabinet behind the transmissive display area and includes a lens positioned for imaging through the transmissive display area.

According to a second aspect of the invention, a method is provided for operating a gaming machine under control of at least one electronic processor. The method includes displaying gaming graphics on a video display system of the gaming machine including a transmissive display area. The method includes recognizing an event or command for a player image acquisition, and in response interrupting the gaming graphics for a designated number of video frames on at least a portion of the transmissive display area and increasing the transparency of said at least a portion to allow an image to be acquired through the transmissive display area with an electronic camera. The method includes acquiring an image with the electronic camera during the interruption.

Another aspect of the invention is a computer program stored on a tangible non-transitory readable medium. The software version is, of course, typically designed to be executed by a gaming machine or networked gaming system. The software includes multiple portions of computer executable code referred to as program code. Gaming results are provided in response to a player activation and displayed by display program code that controls the mechanical reel display and transmissive display according to the method summarized above.

In some implementations, a mechanical reel display mounted in the cabinet includes multiple reels each with multiple symbols thereon. The electronic controller controls the mechanical reel display and the transmissive video display and is further programmed for causing the reels to spin and stop to display symbols on selected symbol locations visible through the transmissive video display.

In some implementations, the transmissive display area comprises a transmissive display window positioned within a larger non-transmissive display area. The transmissive display window may be much smaller than the total display area. For example, in some implementations, the transmissive display area includes an area no greater than 10% of the video display device, and in some an area no than 5% of the video display device.

In some implementations, the electronic controller is further programmed for, in a first mode, operating the transmissive display area for displaying gaming graphics, and in a second mode, interrupting the gaming graphics for a designated number of video frames on at least a portion of the transmissive display area and increasing the transparency of said at least a portion to allow an image to be acquired therethrough with the electronic camera.

In some implementations, the electronic controller is further programmed for recognizing an event or command for a player image acquisition, and responsive to recognizing the event or command, causing the video display system to change from the first mode to the second mode and causing an image to be acquired by the electronic camera in the second mode. Following the second mode, the video display system is returned to the first mode.

In some implementations, the electronic controller is further programmed for, in a first mode, operating the transmissive display area for displaying gaming graphics, and in a second mode, repeatedly interrupting the gaming graphics for a designated number of video frames on at least a portion of the transmissive display area and increasing the transparency of said at least a portion to allow a sequence of video frames to be acquired therethrough with the electronic camera.

In some implementations, the electronic controller is further programmed for recognizing an event or command for a player video acquisition. Responsive to recognizing the event or command, the controller causes the video display system to change from the first mode to the second mode and causes multiple video frames to be acquired by the electronic camera in the second mode. Following the second mode, the video display system is returned to the first mode.

Another aspect of the invention is a gaming system that includes one or more gaming servers, and a group of electronic gaming machines connected to the servers by a network, programmed to provide one or more of the methods described herein. The various functionality described herein may be distributed between the electronic gaming machines and the gaming servers in any practically functional way. For example, the current preferred architecture is for the servers to determine all aspects of game logic, random number generation, and prize awards. The servers may be special purpose gaming servers. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Another aspect of the invention is a display unit including a camera mounted therein and positioned as described herein. The display unit is controlled to allow the camera to acquire imagery as described herein.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a front diagram view of a primary video display device of a gaming machine including a matrix of symbol locations and illustrating a number of possible locations for a transmissive window according to various embodiments.

FIG. 2 is a side diagram view of the primary video display device of FIG. 1.

FIG. 3 is a side diagram view of a primary video display device including a mechanical reel assembly according to another embodiment.

FIG. 4 shows a flow diagram of a process for operating a camera according to some embodiments.

FIG. 5 is a perspective view of a gaming machine which is suitable for implementing the transmissive display update processes described herein.

FIG. 6 shows a hardware and logical block diagram of gaming machine according to some embodiments.

### DESCRIPTION OF REPRESENTATIVE EMBODIMENTS

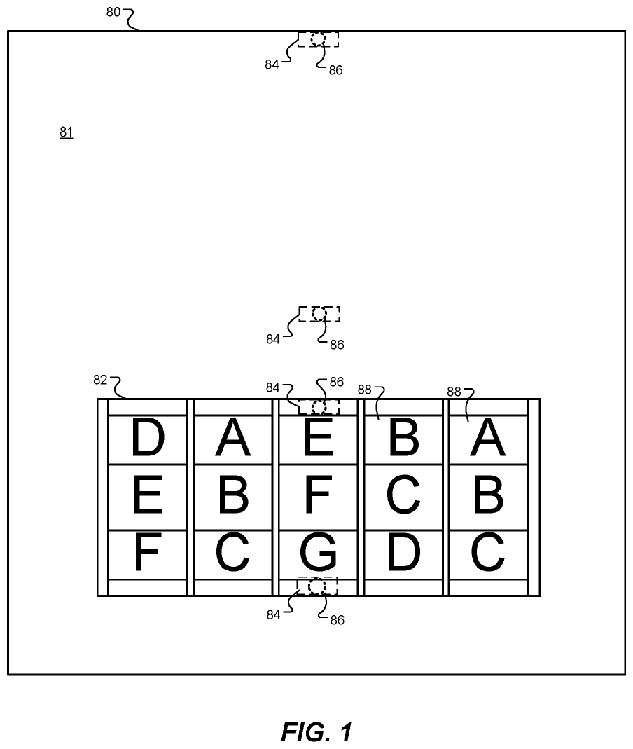

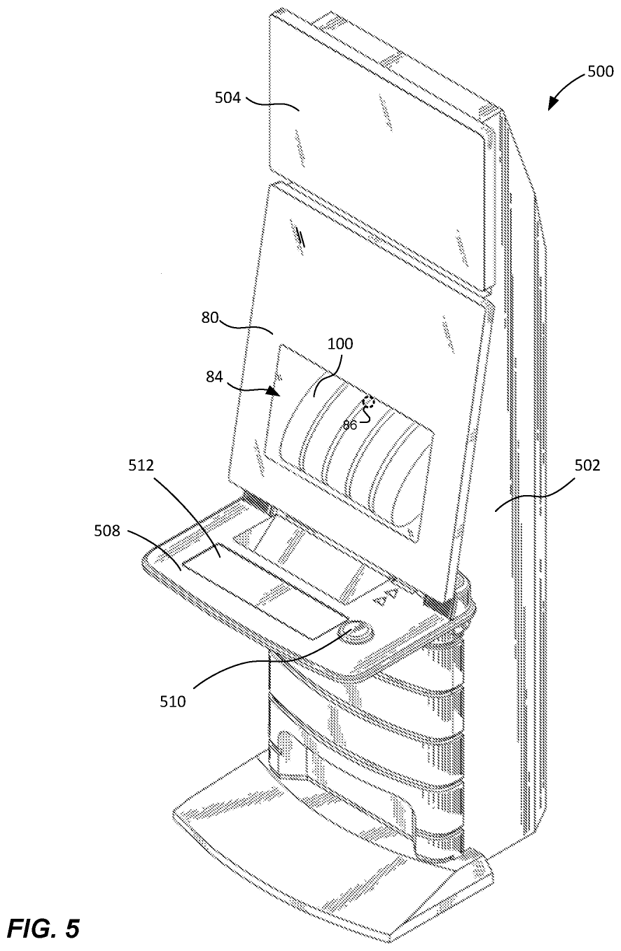

FIG. 1 is a front diagram view of a primary video display device 80 of a gaming machine including a matrix of symbol locations 82 and illustrating a number of possible locations for a transmissive window 84 according to various embodiments. Primary video display device 80 is installed on or in a gaming cabinet such as that of gaming machine 500 shown in FIG. 5.

Primary video display device 80 generally includes matrix of symbol locations 82 and a secondary display area 81, which may display primary game content, bonus game content, paytable information, or background graphics. Primary video display device 80 is generally a non-transmissive display, that is not transparent or translucent, such as a liquid-crystal display (LCD), Organic LED display, or other known flatscreen display. However, primary video display device 80 includes at least one transmissive display area in the form of a transmissive window which can display images but also allow viewing through the display, from the gaming machine interior to its exterior, and from the exterior to the interior. Four transmissive windows 84 are depicted to illustrate possible locations that a transmissive window may be present in primary video display device 80, behind which a camera is mounted.

Typically, only a single transmissive window 84 is used, although more than one may be used in some embodiments. Transmissive window 84 may be constructed as a transmissive display area of the larger primary video display device 80, or a separate small transmissive display integrated with primary video display device 80. In each example location for a transmissive window 84, a designated area 86 is identified inside which graphics may be controlled to better allow imaging through the transmissive window, as further described below.

Matrix of symbol locations 82 includes a number of symbol locations 88 arranged into rows and columns, and typically presented as simulated slot reels in which each column displays a simulated reel which spins and stops to present gaming results. Other game presentation schemes may also be used with the transmissive display area features described herein.

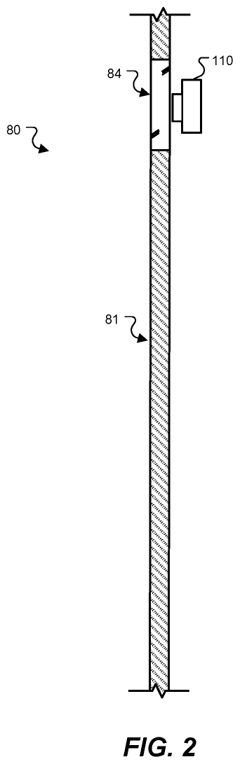

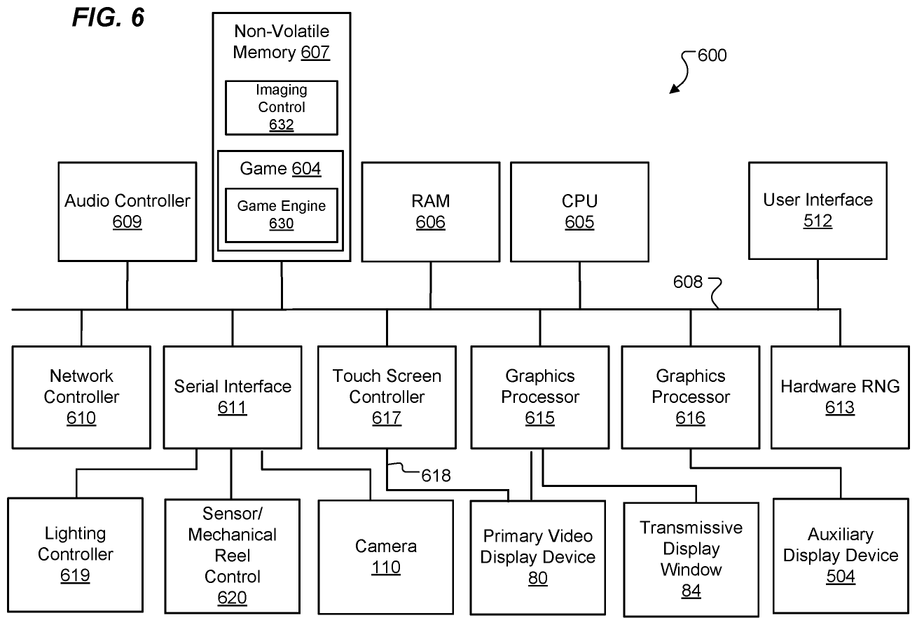

FIG. 2 is a side diagram view of the primary video display device 80 of FIG. 1. A single transmissive window 84 is illustrated with an electronic camera 110 mounted along the back side of the display behind the transmissive display area of transmissive window 84. Camera 110's lens is positioned for imaging through the transmissive display area. Camera 110 is generally used for acquiring images of a player at the gaming machine but may also be used for tasks such as recognizing when a player is standing in front of the gaming machine, acquiring video of a player, or acquiring video or images of the gaming machine surroundings, including foot traffic passing by the gaming machine. Camera 110 is preferably a digital camera coupled to the gaming machine controller over a serial link, as described with respect to FIG. 6, and controlled in combination with the display of graphics on the transmissive display area to acquire images, as further described below.

While in this embodiment, camera 110 is mounted directly behind transmissive window 84, in other embodiments it may be mounted further backwards in the cabinet, such that it is not visible to the player. In some embodiments, a shroud or cover may be placed over the camera and positioned such that the lens is in shadow from the player's view yet still has an unobstructed field of view in the desired area.

In some embodiments, the invention is embodied as a display unit with a camera integrated as described herein, mounted in a common housing with the display unit. While gaming machines are described herein as the preferred implementation, such a display unit may be employed in other devices that require an electronic display and a camera.

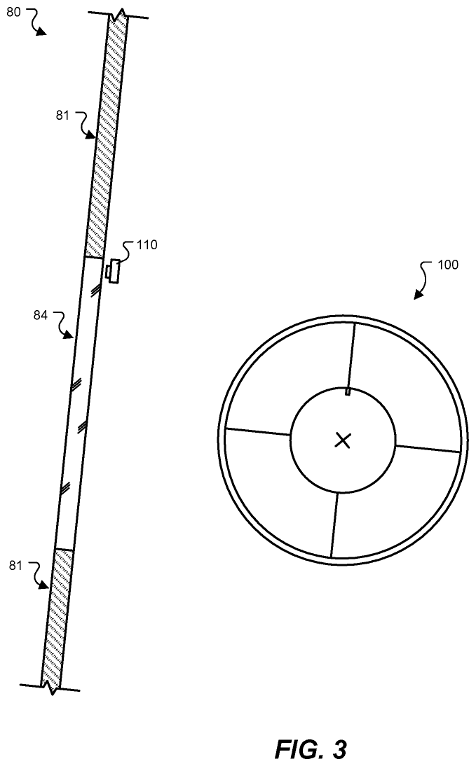

FIG. 3 is a side diagram view of a primary video display device 80 according to another embodiment, including a mechanical reel assembly with five reels 100 visible through a transmissive window 84. In this embodiment, transmissive window 84 provides a transmissive display area that forms a larger window in the primary video display device 80 than those illustrated in FIG. 2. Transmissive window 84 may be implemented as a transmissive video display device able to show video superimposed over a transparent viewing area, or a transmissive region of the larger, non-transmissive area of display device 80. Transmissive window 84 is positioned in front of reels 100, at an angle to allow a player to view reels 100 and any video graphics presented on transmissive window 84 at the same time.

Camera 110 is mounted directly behind transmissive window 84, in this embodiment along the upper edge of transmissive window 84. In other embodiments, camera 110 may be positioned in other locations. For example, camera 110 may be positioned along the bottom edge of transmissive window 84, along a right or left side edge, or further back in the gaming cabinet. For example, camera 110 may be placed at the right or left edge of reels 100 with the lens pointing toward transmissive window 84.

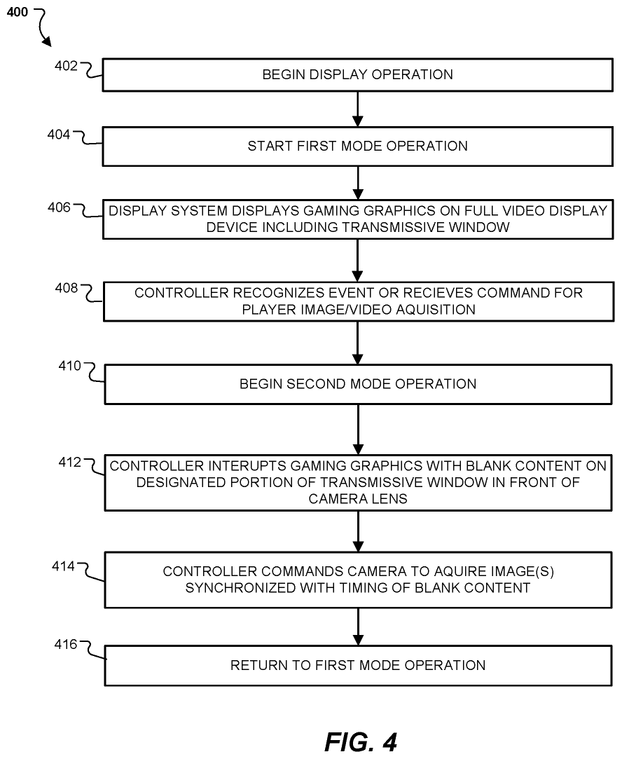

FIG. 4 shows a flow diagram 400 of a process for operating a camera 110 according to some embodiments. The depicted process is suitable for use with the embodiments of FIGS. 1-3, and other embodiments in which a camera is positioned behind a transmissive display area and is pointed through the transmissive display area for imaging in front of the gaming machine. The process begins at block 402, where it begins operating the gaming display including the non-transmissive area, for example secondary display area 81 of FIG. 1, and the transmissive display area, for example 84.

At block 402, the process operates the gaming display in a first mode of operation at block 404. The first mode includes normal operation of the gaming display, in which graphics for the game are displayed on the entire area of the gaming display. This mode is used in an “attract” mode in which no players are present at the gaming machine, and in various login and gaming modes in which a player is present at the gaming machine and interacting with the gaming machine to deposit credits or play games. In the first mode, the transmissive display area is employed for displaying gaming graphics, as shown at block 406 in which the full video display device of the gaming display is used to display gaming graphics. This may include attract mode graphics, login or deposit graphics, base game play graphics, and bonus game play graphics.

At block 408, the gaming machine's controller recognizes an event or receives a command for image acquisition with the camera. This event or command may take a variety of forms. Events may take the form of a player login, a player credit deposit, a player win of a designated type, a player bonus win of a designated type, a timer event reflecting that a player has been playing for a designated time, a timer event reflecting that no player has been logged in for a designated time, or a monitoring event reflecting that an image is desired of the gaming machine surroundings to monitor such activity as foot traffic or other activity near the gaming machine. Such events may be recognized by the gaming machine based on a variety of inputs or software events. For example, the gaming engine software (630, FIG. 6) may send inter-process messages to an imaging control software (632) to generate the event. As another example, the imaging control software may operate timers or other monitoring processes and generate its own events. Commands may also be received over a network to achieve the same result. For example, a casino management server may be connected to the host gaming machine over a network and may send a command requesting an image be taken at the gaming machine.

In response to the event or command in block 408, the process at block 410 begins a second mode of operation in which it interrupts the gaming graphics for a designated number of video frames on at least a portion of the transmissive display area. This increases the transparency of said at least a portion to allow image(s) to be acquired therethrough with the electronic camera. The gaming graphics may be interrupted as shown at block 412 over the entire area of transmissive window 84 (FIG. 1), or on a designated area 86 located in front of camera 110's lens. The designated number of video frames is selected to be long enough to allow an image to be acquired, which may be one or two frames or three in some versions. In the second mode, a single image or stream of video images may be acquired as shown at block 414. To allow video to be acquired, the second mode may include repeatedly interrupting the graphics. For example, if sixty frames-per-second (fps) video is displayed on primary video display device 80 including transmissive window 84, and camera 110 is capable of acquiring sixty fps video, alternating frames of the video display may be interrupted to make every other frame transparent in the desired display area (86). During this period a frame can be acquired by camera 110. If the response time of the display does not allow such a scheme, a slower interruption may be used such as two frames of interrupted graphics for every one frame of displayed graphics, resulting in a 20 fps video being acquired.

The interruption of the video is performed in such a way that the transmissive display achieves its maximum possible transparency, of course limited by the desired response time. Depending on the transmissive display technology (sometimes called “transparent display”) the interruption is performed by displaying “black” pixels, or commanding that the pixels in the desired area are turned off, for example. For organic LED (OLED) displays, turning the pixels off or black is used. For LCD technologies, a backlight pixel may also need to be turned off to achieve maximum transparency. In other technologies, any other suitable means to make the display achieve its maximum transparency in the desired area may be used.

At block 416, when the desired image or images have been acquired, the process returns to the first mode of operation in which the entire area of the display system is used to display graphics.

FIG. 5 is a perspective view of a gaming machine 500 which is suitable for implementing the transmissive display update processes described herein. Gaming machine 500 includes a cabinet 502 that houses various elements of the gaming machine. A front side of cabinet 502 supports an upper display device 504 and a lower display device 80. The front side of cabinet 502 also supports a button deck 508 that contains various player controls and interface devices including play button 510 and a touch screen button panel/user interface 512.

Integrated with lower display device 80 is transmissive window 84 through which may be viewed mechanical reels 100. Transmissive window 84 may display gaming graphics while reels 100 are not lighted and therefore have low visibility, and may display additional graphic elements overlaying reels 100 when reels 100 are in use and lighted, some of which are animated to move along with movement of symbols on mechanical reels 100. An area 86 is identified, behind which a camera is positioned to acquire images as described herein.

It will be appreciated that gaming machines may also include a number of other player interface devices in addition to devices that are considered player controls for use in entering inputs in the course of a particular game. For example, gaming machine 500 may include a currency/voucher acceptor, a voucher/receipt printer having a voucher/receipt printer, and a player card reader although these elements are not called out in FIG. 5. Numerous other types of player interface devices may be included in gaming machines that may be used to implement embodiments of the present invention.

FIG. 6 shows a hardware and logical block diagram of gaming machine 600 which includes a central processing unit (CPU) 605 along with random access memory 606 and nonvolatile memory or storage device 607. The depicted design is suitable for implementing a gaming machine 500 (FIG. 5) or other similar gaming machines including a camera for imaging through a transmissive display area. Gaming machine 600 may embody a special purpose gaming machine including a hardware configuration approved by a regulatory gaming authority for use in casino gaming. Such hardware configuration may include as part of non-volatile memory 607 a read-only memory (ROM) which is regulated validated and approved by the gaming authority for holding gaming code described herein such as the operating system, the gaming software module 604, the gaming engine 630, or other software modules such as a software random number generator. CPU 605 may include a security processor core programmed for checking the validity of non-volatile memory 607, including any ROM devices, before allowing gaming machine 600 to boot and operate. Examples of such gaming authorities include the National Indian Gaming Commission (NIGC), the Arizona Department of Gaming, the California Bureau of Gambling Control, the California Gambling Control Commission, the Delaware Division of Gaming Enforcement, the Illinois Gaming Board, the Michigan Gaming Control Board, the Minnesota Alcohol and Gambling Enforcement Division, the Missouri Gaming Commission, the Nevada Gaming Commission, the Nevada Gaming Control Board, the New Jersey Casino Control Commission, the New Jersey Division of Gaming Enforcement, the New York State Gaming Commission, the Ohio Casino Control Commission, the Pennsylvania Gaming Control Board, the South Dakota Commission on Gaming, the Washington State Gambling Commission, and the West Virginia Lottery. Other similar non-U.S. gaming commissions may also approve such special purpose hardware.

The depicted devices in FIG. 6 are connected on a system bus 608 with an audio controller 609, a network controller 610, and a serial interface 611. Serial interface 611 connects to reel position sensor/mechanical reel controller 620, which controls the movement of reels 100. Serial interface 611 also connects to camera 110, and to lighting controller 619 for controlling various lighting effects on cabinet 502. A graphics processor 615 is connected to system bus 608 and is connected to drive primary video display device 80 (mounted in cabinet 502 as shown in FIG. 5) and transmissive window 84. A second graphics processor 616 may be present on system bus 608 and used to drive secondary displays such as auxiliary display device 504. Gaming machine 600 also includes a touch screen controller 617 connected to system bus 608. Touch screen controller 617 is also connected via signal path 618 to receive signals from a touchscreen element associated with primary video display device 80. It will be appreciated that the touchscreen element itself typically comprises a thin film that is secured over the display surface of primary video display device 80. The touchscreen element itself is not illustrated or referenced separately in the figures, and is not used in some embodiments.

Those familiar with data processing devices and systems will appreciate that other common electronic components will be included in gaming machine 600 such as a power supply, cooling systems for the various system components, audio amplifiers, and other devices that are common in gaming machines. These additional devices are omitted from the drawings so as not to obscure the present invention in unnecessary detail.

Generally, the hardware elements shown in FIG. 6 are known elements used in the gaming machine industry. These elements are preferably mounted in a computer chassis which is housed in cabinet 502 shown in FIG. 5. Alternatively, the various electronic components may be mounted on one or more circuit boards or modules housed within cabinet 502 without a separate enclosure. Those familiar with data processing systems and the various data processing elements shown in FIG. 6 will appreciate that many variations on this illustrated structure may be used within the scope of the present invention. For example, since serial communications are commonly employed to communicate with a touch screen controller such as touch screen controller 617, the touch screen controller may not be connected on system bus 608, but instead include a serial communications line to serial interface 611, which may be a USB controller or a IEEE 1394 controller for example. It will also be appreciated that some of the devices shown in FIG. 6 as being connected directly on system bus 608 may in fact communicate with the other system components through a suitable expansion bus. Audio controller 609, for example, may be connected to the system via a PCI bus. System bus 608 is shown in FIG. 6 merely to indicate that the various components are connected in some fashion for communication with game processor/CPU 605 and is not intended to limit the invention to any particular bus architecture. Numerous other variations in the gaming machine internal structure and system may be used without departing from the principles of the present invention.

Although separate graphics processor 615 is shown for controlling primary video display device 80, and graphics processor 616 is shown for controlling auxiliary display device 504, it will be appreciated that game processor/CPU 605 may control all of the display devices directly without any intermediate graphics processor. The invention is not limited to any particular arrangement of processing devices for controlling the video display device included with gaming machine 600. Also, a gaming machine implementing the present invention is not limited to any particular number of video display devices or other types of display devices.

In the illustrated gaming machine 600, game processor/CPU 605 loads and executes gaming engine software 630 which ultimately controls the entire gaming machine including the receipt of player inputs and the presentation of the graphic symbols displayed, according to the invention, on display device 80, transmissive window 84, and display 504 of gaming machine 600. Game engine 630 may include a presentation controller for performing functions associated with a primary game that may be available through the gaming machine, executed by game processor/CPU 605 either alone or in combination with graphics processor 615. Imaging control software 632 is loaded into RAM 606 from non-volatile memory 607 for directing camera 110 and controlling the two modes of transmissive display window 84 as described herein. For example, imaging control software 632 may send and receive network traffic using network controller 610 and execute the methods described with respect to FIG. 4, or other suitable variations thereof.

Game processor/CPU 605 also executes software related to communications handled through network controller 610, and software related to various peripheral devices such as those connected to the system through audio controller 609, serial interface 611, and touch screen controller 617. Game processor/CPU 605 may also execute software to perform accounting functions associated with game play. Random access memory 606 provides memory for use by game processor/CPU 605 in executing its various software programs, while the nonvolatile memory or storage device 607 may comprise a hard drive or other mass storage device providing storage for programs not in use or for other data generated or used in the course of gaming machine operation. Network controller 610 provides an interface to other components of a gaming system in which gaming machine 600 is included.

It should be noted that the invention is not limited to gaming machines employing the arrangement of processing devices and interfaces shown in example gaming machine 600. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 605, these special purpose processing devices may not employ operational program code to direct the various processing steps. Further, other display devices may employ a display system as described herein if imaging control software 632 is employed to control display for allowing imaging through the display.

Still referring to FIG. 6 showing an example design for a gaming machine 600, the depicted machine in operation is controlled generally by game processor/CPU 605 which stores operating programs and data in non-volatile memory or storage device 607 with game software module 604, and software or drivers for user interface 512, network controller 610, audio/visual controllers, and a hardware random number generator (RNG) 613, which is employed if software RNG procedures are not allowed in a particular gaming jurisdiction. Either hardware RNG 613 or a suitable software RNG are employed for making the random selections of game outcomes, reel stop positions, etc. when operating the game as described herein.

The game software module 604, once installed, also is held in non-volatile memory of the gaming machine, preferably a separate flash drive or hard drive from the memory holding the gaming machine operating system. CPU or game processor/CPU 605 may comprise a conventional microprocessor, such as an Intel microprocessor, mounted on a printed circuit board with supporting ports, drivers, memory, software, and firmware to communicate with and control gaming machine operations, such as through the execution of code stored in non-volatile memory or storage device 607. Such executed code includes a game software 604 for executing game modules and including software for controlling a mechanical reel presentation through sensor/mechanical reel controller 620. Game processor/CPU 605 connects to user interface 512 such that a player may enter input information, and game processor/CPU 605 may respond according to its programming, such as to apply a wager and initiate execution of a game.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of the invention, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A gaming machine comprising:
a cabinet having a front side and at least one player input device;
a video display system mounted in the cabinet and comprising a video display device with a transmissive display area;
at least one electronic controller coupled to the at least one player input device and the video display system and programmed for presenting a gaming result responsive to an input from the player input device; and
an electronic camera mounted in the cabinet behind the transmissive display area and comprising a lens positioned for imaging through the transmissive display area.

2. The gaming machine of claim 1 further comprising:
a mechanical reel display mounted in the cabinet and comprising multiple reels each with multiple symbols thereon, wherein the at least one electronic controller is coupled to control the mechanical reel display and the video display system and further programmed for causing the reels to spin and stop to display symbols on selected symbol locations visible through the transmissive display area.

3. The gaming machine of claim 1 wherein the transmissive display area comprises a transmissive display window positioned within a larger non-transmissive display area.

4. The gaming machine of claim 2 wherein the transmissive display area comprises an area no greater than 10% of the video display device.

5. The gaming machine of claim 1 wherein the transmissive display area comprises an area no greater than 5% of the video display device.

6. The gaming machine of claim 1 wherein the at least one electronic controller is further programmed for, in a first mode, operating the transmissive display area for displaying gaming graphics, and in a second mode, interrupting the gaming graphics for a designated number of video frames on at least a portion of the transmissive display area and increasing transparency of said at least a portion to allow an image to be acquired therethrough with the electronic camera.

7. The gaming machine of claim 6 wherein the at least one electronic controller is further programmed for:
recognizing an event or command for a player image acquisition;
responsive to recognizing the event or command, causing the video display system to change from the first mode to the second mode and causing an image to be acquired by the electronic camera in the second mode; and
following the second mode, causing the video display system to return to the first mode.

8. The gaming machine of claim 1 wherein the at least one electronic controller is further programmed for, in a first mode, operating the transmissive display area for displaying gaming graphics, and in a second mode, repeatedly interrupting the gaming graphics for a designated number of video frames on at least a portion of the transmissive display area and increasing transparency of said at least a portion to allow a sequence of video frames to be acquired therethrough with the electronic camera.

9. The gaming machine of claim 8 wherein the at least one electronic controller is further programmed for:
recognizing an event or command for a player video acquisition;
responsive to recognizing the event or command, causing the video display system to change from the first mode to the second mode and causing multiple video frames to be acquired by the electronic camera in the second mode; and
following the second mode, causing the video display system to return to the first mode.

10. A method of operating a gaming machine under control of at least one electronic processor, the method comprising:
displaying gaming graphics on a video display system of the gaming machine comprising a transmissive display area;
recognizing an event or command for a player image acquisition;
interrupting the gaming graphics for a designated number of video frames on at least a portion of the transmissive display area and increasing transparency of said at least a portion to allow an image to be acquired through the transmissive display area with an electronic camera;
acquiring an image with the electronic camera during the interruption.

11. The method of claim 10 wherein the transmissive display area comprises a transmissive display window positioned within a larger non-transmissive display area.

12. The method of claim 10 wherein the gaming graphics are interrupted on a designated portion of the transmissive display area in front of a lens of the electronic camera.

13. The method of claim 10 wherein recognizing an event or command comprises recognizing a bonus outcome event of a game.

14. The method of claim 10 wherein recognizing an event or command comprises recognizing a player login event.

15. One or more tangible, non-transitory computer readable media holding instructions executable by at least one electronic processor of a gaming machine for:
displaying gaming graphics on a video display system of the gaming machine comprising a transmissive display area;
recognizing an event or command for a player image acquisition;
interrupting the gaming graphics for a designated number of video frames on at least a portion of the transmissive display area and increasing transparency of said at least a portion to allow an image to be acquired therethrough with an electronic camera;
acquiring an image with the electronic camera during the interruption.

16. The one or more tangible, non-transitory computer readable media of claim 15 wherein the transmissive display area comprises a transmissive display window positioned within a larger non-transmissive display area.

17. The one or more tangible, non-transitory computer readable media of claim 15 wherein the gaming graphics are interrupted on a designated portion of the transmissive display area in front of a lens of the electronic camera.

18. The one or more tangible, non-transitory computer readable media of claim 15 wherein recognizing an event or command comprises recognizing a bonus outcome event of a game.

19. The one or more tangible, non-transitory computer readable media of claim 15 wherein recognizing an event or command comprises recognizing a player login event.
